(19) United States
(12) Patent Application Publication
(10) Pub. No.: US 2023/0260068 A1
(43) Pub. Date: Aug. 17, 2023

(54) METHOD, SYSTEM AND COMPUTER PROGRAM PRODUCT FOR VIOLATION ASSESSMENT IN RESPECT OF INITIATING A VEHICLE STOP

(71) Applicant: MOTOROLA SOLUTIONS, INC., CHICAGO, IL (US)

(72) Inventors: PIETRO RUSSO, MELROSE, MA (US); ZACHARY WEINGARTEN, MEDFORD, MA (US); ALEKSEY LIPCHIN, NEWTON, MA (US); DORAN INGALLS, BURNABY (CA)

(21) Appl. No.: 17/651,470

(22) Filed: Feb. 17, 2022

(51) Int. Cl. G06Q 50/26; G06F 16/583; G06V 20/54; G06V 20/62; G06V 40/16; G06V 10/82; G08B 7/06

(52) U.S. Cl. CPC G06Q 50/265; G06F 16/583; G06V 20/54; G06V 20/625; G06V 40/172; G06V 10/82; G08B 7/06; G06V 2201/08; G06V 2201/10

(57) ABSTRACT

There is disclosed a method that includes analyzing, using an at least one processor, image data to generate or facilitate acquisition of violation assessment data associated with a vehicle or an owner of that associated vehicle. The method also includes receiving, at the at least one processor, input originating from a police officer indicating an intention to stop the vehicle. The method also includes making a determination, at the at least one processor, whether the violation assessment data supports affirming the stop of the vehicle as a compliant stop, or whether the violation assessment data supports disaffirming the stop of the vehicle. The method also includes transmitting a notification in respect of the stop of the vehicle to a display or speaker perceptible to the police officer. The notification informs as to compliancy or non-compliancy of the stop of the vehicle.

### BACKGROUND

It is not uncommon for police officers to come under scrutiny for allegedly abusing their authority or allegedly not complying with some required protocol governing their conduct. Also, police officers in many jurisdictions need to have justification to pull over (or stop) a vehicle. Depending on the circumstances, a suspicion requirement (or some other similar requirement as spelled out in the law and/or regulations of the jurisdiction) might be a prerequisite for a police officer to justify certain actions such as, for example, conducting a search, asking someone to submit to a sobriety test, etc. Proper documentation of a vehicle stop, including preserved evidence in support of the legal requirements of the vehicle stop being satisfied, may help police officers in, for example, defending themselves in court.

### BRIEF DESCRIPTION OF THE SEVERAL VIEWS OF THE DRAWINGS

In the accompanying figures similar or the same reference numerals may be repeated to indicate corresponding or analogous elements. These figures, together with the detailed description, below are incorporated in and form part of the specification and serve to further illustrate various embodiments of concepts that include the claimed invention, and to explain various principles and advantages of those embodiments.

FIG. 1 is a block diagram of a system in accordance with example embodiments;

FIG. 2 is a flow chart illustrating a computer-implemented method in accordance with an example embodiment; and

FIG. 3 is a schematic diagram of a practical implementation, in accordance with example embodiments, of the system of FIG. 1.

Skilled artisans will appreciate that elements in the figures are illustrated for simplicity and clarity and have not necessarily been drawn to scale. For example, the dimensions of some of the elements in the figures may be exaggerated relative to other elements to help improve understanding of embodiments of the present disclosure.

The system, apparatus, and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION OF THE INVENTION

In accordance with one example embodiment, there is provided a method that includes obtaining at least one image within which is shown at least a portion of a vehicle. The method also includes receiving, at an at least one processor, image data for the at least one image. The method also includes analyzing, using the at least one processor, the image data to generate or facilitate acquisition of violation assessment data associated with the vehicle or an owner of the vehicle. The method also includes receiving, at the at least one processor, input originating from a police officer indicating an intention to stop the vehicle. The method also includes making a determination, at the at least one processor, whether the violation assessment data supports affirming the stop of the vehicle as a compliant stop, or whether the violation assessment data supports disaffirming the stop of the vehicle. The method also includes transmitting a notification in respect of the stop of the vehicle to a display or speaker perceptible to the police officer. The notification informs as to compliancy or non-compliancy of the stop of the vehicle.

In accordance with another example embodiment, there is provided a system that includes at least one camera configured to capture at least one image within which is shown at least a portion of a vehicle. The system also includes at least one processor, communicatively coupled to the at least one camera, and configured to receive image data therefrom for the at least one image. The at least one processor is further configured to analyze the image data to generate or facilitate acquisition of violation assessment data associated with the vehicle or an owner of the vehicle. The at least one processor is also further configured to receive input originating from a police officer indicating an intention to stop the vehicle. The at least one processor is also further configured to make a determination whether the violation assessment data supports affirming the stop of the vehicle as a compliant stop, or whether the violation assessment data supports disaffirming the stop of the vehicle. The at least one processor is also further configured to generate a notification in respect of the stop of the vehicle. The system also includes display or speaker, perceptible to the police officer, and communicatively coupled to the at least one processor to receive therefrom the notification that informs as to compliancy or non-compliancy of the stop of the vehicle.

Each of the above-mentioned embodiments will be discussed in more detail below, starting with example system and device architectures of the system in which the embodiments may be practiced, followed by an illustration of processing blocks for achieving an improved technical method, device, and system for violation assessment in respect of initiating a vehicle stop.

Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a special purpose and unique machine, such that the instructions, which execute via the processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus that may be on or off-premises, or may be accessed via the cloud in any of a software as a service (SaaS), platform as a service (PaaS), or infrastructure as a service (IaaS) architecture so as to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

The term “vehicle” as used herein is understood to mean a human-occupiable machine (such as, for example, a car, bus, van, truck, motorcycle, bicycle, etcetera) that is suitable for travel on roads.

The term “speaker” as used herein means an electrical device that converts electrical energy into sound waves perceptible to a human (such as, for example, a loudspeaker, earphones, headphones, etcetera).

The term “image data” as used herein includes actual image(s), image metadata, actual video, video metadata, or some combination of these.

Further advantages and features consistent with this disclosure will be set forth in the following detailed description, with reference to the figures.

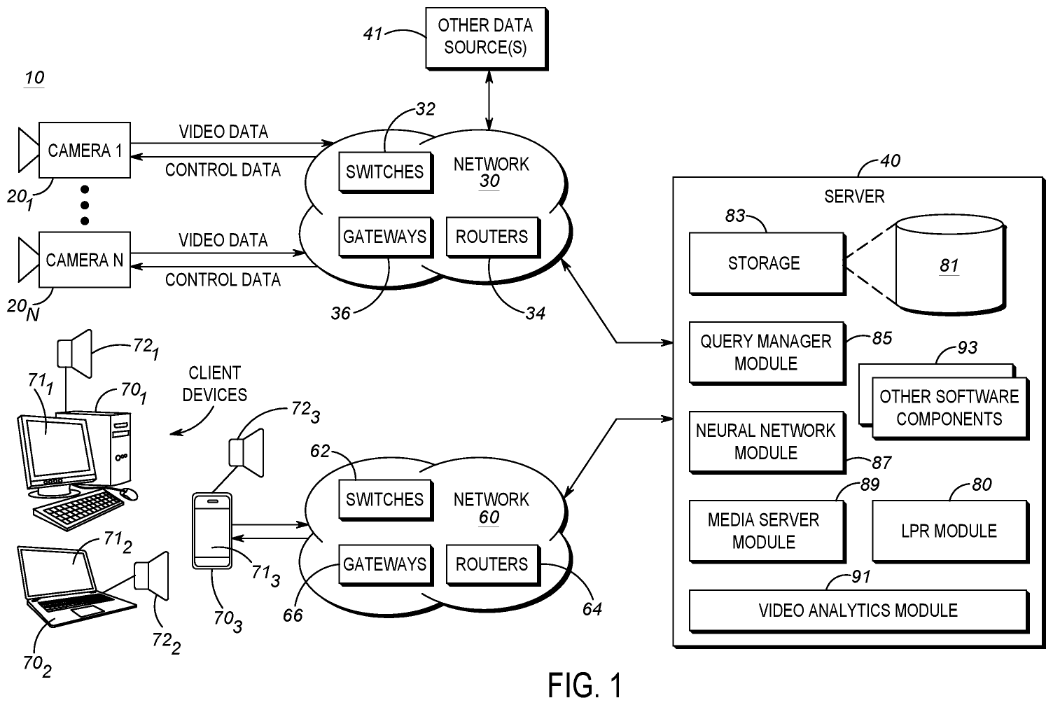

Referring now to the drawings, and in particular FIG. 1, which is a block diagram of a system 10. The illustrated system 10 includes a plurality of cameras 20₁-20_{N} which are coupled to a network 30 (which may comprise a plurality of networks, even though shown as a single network in FIG. 1 for convenience of illustration). The network 30 can include the Internet, or one or more other public/private networks coupled together by communication elements: for example, one or more network switches 32, one or more routers 34, and/or one or more gateways 36. The network 30 could be of the form of, for example, client-server networks, peer-to-peer networks, etc. Data connections between any of the cameras 20₁-20_{N} and other network devices can be any number of known arrangements for accessing a data communications network, such as, for example, dial-up Serial Line Interface Protocol/Point-to-Point Protocol (SLIP/PPP), Integrated Services Digital Network (ISDN), dedicated lease line service, broadband (e.g. cable) access, Digital Subscriber Line (DSL), Asynchronous Transfer Mode (ATM), Frame Relay, or other known access techniques (for example, radio frequency (RF) links). In at least one example embodiment, the cameras 20₁-20_{N} and the other illustrated network devices are within the same Local Area Network (LAN).

Still with reference to FIG. 1, the cameras 20₁-20_{N} communicate data and information to and from other network devices via the network 30. Two examples of such data and information, amongst other examples, are shown for convenience of illustration. For instance, the cameras 20₁-20_{N} transmit video data to one or more other network devices via the network 30. As another example, the cameras 20₁-20_{N} receive control data from other network devices via the network 30. In some example embodiments, the cameras 20₁-20_{N} are fixed-mounted types of video cameras such as, for instance, License Plate Recognition (LPR) cameras, Pan-Tilt-Zoom (PTZ) cameras, box cameras, bullet cameras, etc. In other example embodiments, the cameras 20₁-20_{N} are some other type of camera such as, for instance, body-worn cameras, police vehicle cameras, dash cameras, other types of non-static location cameras, etc. (In some cases, the camera(s) may be specifically assigned to a police officer on-duty.) Also, it will be understood that the cameras 20₁-20_{N} need not all be collectively of homogeneous type, and any suitable combination of cameras of different types (i.e. a heterogeneous combination of cameras) is also contemplated.

Also shown in FIG. 1 is a server 40 which is coupled to the network 30 to receive data and information from other devices on the network 30 such as, for example, other data sources 41 and any of the cameras 20₁-20_{N}. By way of a network 60, the server 40 is also coupled to client devices 70₁-70₃ (although three shown for convenience of illustration, any suitable positive integer number is contemplated) so that the server 40 may, for example, send and receive data and information between the client devices 70₁-70₃ and the server 40.

Continuing on, each of the client devices 70₁-70₃ includes a respective one of display screens 71₁-71₃ for displaying text and/or graphics. Additionally, it will be understood that implementations of display screens will vary. In some examples, one or more of the display screens 71₁-71₃ may be integral to the respective one or more of the client devices 70₁-70₃. In other examples, one or more of the display screens 71₁-71₃ may be in their own housing or enclosure different from the housing or enclosure of the respective one or more of the client devices 70₁-70₃. In other examples, one or more of the display screens 71₁-71₃ may be attachable to a part of an interior of a vehicle such as, for instance, a vehicle dashboard or a vehicle roof. Also illustrated are speakers 72₁-72₃ that may be integral (or otherwise communicatively coupled, in a wired or wireless manner) to the client devices 70₁-70₃.

With reference again to the network 60, this may comprise a plurality of networks even though shown as a single network in FIG. 1 for convenience of illustration. The network 60 can include the Internet, or one or more other public/private networks coupled together by communication elements: for example, one or more network switches 62, one or more routers 64, and/or one or more gateways 66. The network 60 could be of the form of, for example, client-server networks, peer-to-peer networks, etc. Data connections between any of the client devices 70₁-70₃ and other network devices can be any number of known arrangements for accessing a data communications network, such as, for example, dial-up SLIP/PPP, ISDN, dedicated lease line service, broadband (e.g. cable) access, DSL, ATM, Frame Relay, or other known access techniques (for example, RF links). Although in the illustrated example embodiment the network 30 and the network 60 are shown as separate, in some examples there may be some overlap and commonality between the network 30 and the network 60. In at least one example, the network 60 and the network 30 may be the same network.

Still with reference to FIG. 1, the illustrated server 40 includes an LPR module 80. The LPR module 80 enables various LPR-related functions including, for example, license plate localization, license plate sizing and orientation (adjusting), normalization, character segmentation, Optical Character Recognition (OCR) and syntactical/geometrical analysis. The server 40 also includes a database 81 maintained within storage 83. Amongst other things, the database 81 is organized storage for: i) images and/or video footage of vehicles; and ii) metadata corresponding to i).

The server 40 also includes a query manager module 85 (provides any of the client devices 70₁-70₃ an interface for retrieving information from the database 81), a neural network module 87 (explained later herein), a media server module 89 to control streaming of audio and video data (in any suitable manner as will be readily understood by those skilled in the art), and a video analytics module 91 (explained later herein). The server 40 also includes other software components 93. These other software components will vary depending on the requirements of the server 40 within the overall system. As just one example, the other software components 93 might include special test and debugging software, or software to facilitate version updating of modules within the server 40.

Regarding the video analytics module 91, this may operate cooperatively with the neural network module 87 to identify, from image data received at (or stored within) the server 40, features of a vehicle such as, for example, one or more of make, model and color of the vehicle. The video analytics module 91 may also include sub-modules such as, for example, a face recognition sub-module, and object detector(s) (to detect, for instance, windshields and faces within those windshields that may become face recognition candidates). The video analytics module 91 may also operate cooperatively with the neural network module 87 to automatically identify vehicle violations from image data received at the server 40. Examples of detectable violations may include dangerous windshield cracks, wrong type of vehicle tire(s) being used on a vehicle, window or windshield structural integrity issues, window/windshield/mirror visibility impairment, lighting issues, cargo securing/loading issues, etc. More details of some aspects of the video analytics module 91 and the neural network module 87 are disclosed in US Pat. Publ. No. 2021/0241405 entitled “METHOD, SYSTEM AND COMPUTER PROGRAM PRODUCT FOR AUTOMATED PROCESSING, ENFORCEMENT AND INTELLIGENT MANAGEMENT OF VEHICLE OPERATION VIOLATIONS”.

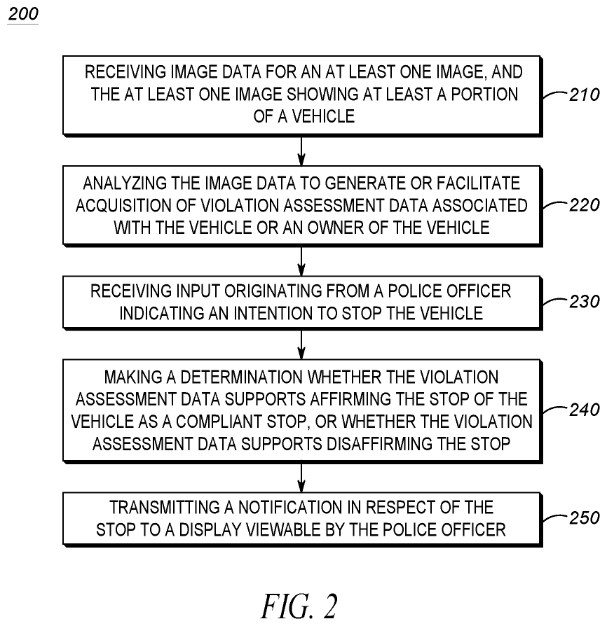

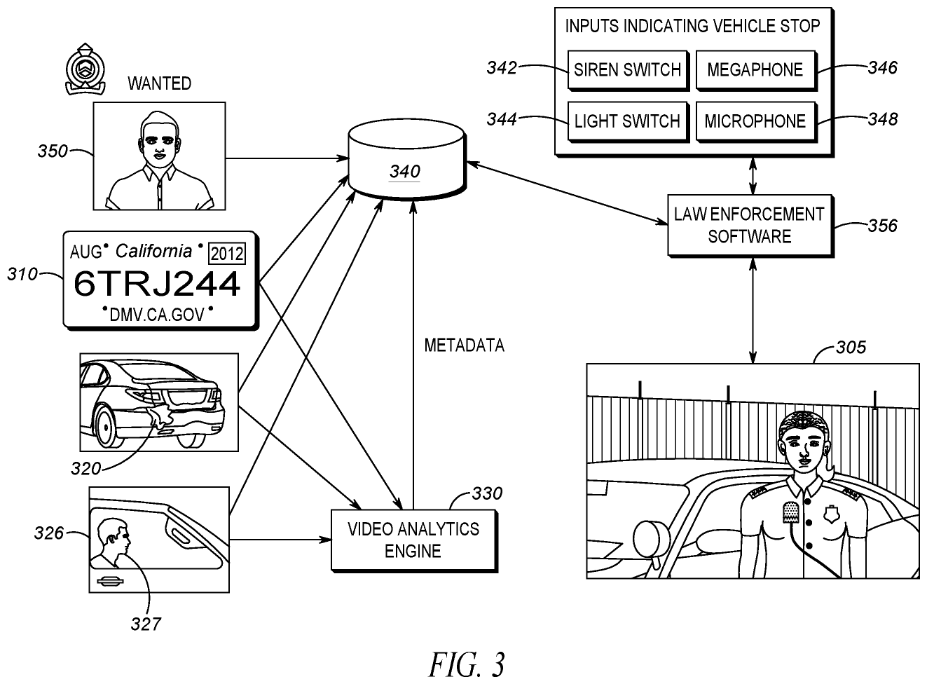

Reference is now made to FIGS. 2 and 3. FIG. 2 is a flow chart illustrating a computer-implemented method 200 in accordance with an example embodiment. FIG. 3 is a block diagram providing illustrative example details consistent with the example embodiment of FIG. 2.

Referring to FIG. 2, the method 200 begins with image data being received (210) for an at least one image, and this image(s) being image(s) that show at least one portion of a vehicle. For example, one or more of the cameras 20₁-20_{N} (FIG. 1) may capture image(s) (such as, for instance still image(s) or video) showing at least one portion of a vehicle proximate (for example, within camera range) to a police officer 305 (FIG. 3). Portions of vehicles that may appear within captured images (storable along with respective metadata in database 340) include, for example, a license plate 310, a taillight 320 and a windshield 326 (all shown in FIG. 3). Also, these the image(s) may be received at an at least one processor (illustratively represented in FIG. 3 as video analytics engine 330 which may correspond to, for example, the video analytics module 91 in FIG. 1). Also, those skilled in the art will appreciate that the at least one processor carrying out the above-described video analytics may be found entirely at one location (for example, within the server 40 of FIG. 1) or alternatively there may be a plurality of processors involved, which may also be spread across the edge and other part(s) of the system 10.

Regarding the aforementioned windshield 326, there is also illustrated a facial recognition candidate 327 visible through the at least substantially transparent windshield 326. Thus, in accordance with some example embodiments, facial recognition is contemplated which may permit, for example, other person(s) beyond simply the registered owner of the vehicle being pulled over or stopped.

Continuing on in the method 200, next image data is analyzed (220) to generate or facilitate acquisition of violation assessment data associated with the vehicle or an owner of the vehicle. The violation assessment data that is generated (or acquired) may correspond to different types of actionable violations, offences or crimes including, for example: i) at least one potential vehicle operation violation for the vehicle preliminarily determined via analytics, or ii) at least one outstanding arrest warrant against the owner of the vehicle (in at least one example regarding ii), after a vehicle has been identified by way of video or other analytics, the registered owner of that vehicle along with any outstanding arrest warrant matching the registered owner may be obtained from the other data sources(s) 41 (FIG. 1)). Also, it will be understood that reference numeral 350 in FIG. 3 corresponds to a diagram element that represents arrest warrant data.

In accordance with example embodiments, the analyzing of the image data may include identifying a license plate number of the vehicle (for instance, carrying out a license plate recognition operation such as, for example, OCR on the license plate 310). The analyzing of the image data may also include identifying at least one of make, model and color of the vehicle. The analyzing of the image data may also include detecting erratic driving in relation to the vehicle. In some examples, video analytics or some other type of analytics may be carried out on video or image(s) to generate metadata, and then afterwards this metadata may be further processed to generate violation assessment data.

Next in the method 200, input originating from a police officer (for example, the police officer 305) is received (230) indicating an intention to stop the vehicle. The input may originate from some device or special-purpose equipment operable by the police officer. For instance, the input may come from at least one of the following examples (alone or in combination): a siren switch 342, a light switch 344, activation of a megaphone 346, an audible cue received at a microphone 348. Also, the input may be received at an at least one processor (for example, received at a processor running law enforcement software 356). Also, in addition to the law enforcement software 356 being reactive to a triggering input from the police officer 305, it is also contemplated that the law enforcement software 356 may operate more proactively. For instance, video analytics may detect that a particular vehicle has been followed by the police officer 305 for a duration of time in excess of some threshold, and then the law enforcement software 356 may actively prompt the police officer 305 to provide input confirm or disaffirming an intention to stop a vehicle.

Next, a determination is made (240) whether the violation assessment data supports affirming the stop of the vehicle as a compliant stop, or whether the violation assessment data supports disaffirming the stop. In some examples, the action 240 is carried out by the law enforcement software 356 running on an at least one processor.

Next, a notification is transmitted (250) in respect of the stop to a display (for example, one of the display screens 71₁-71₃) or a speaker (for example, one of the speakers 72₁-72₃) where the display or speaker is perceptible to the police officer (for example, the police officer 305). The notification received by the police officer (via one or both of these types of devices) informs as to compliancy or non-compliancy of the stop.

After a vehicle stop has been completed, it is contemplated that the violation assessment data may, in some instances, be employed again for making further determination(s). This may be particularly useful where a legal standard for taking some further action (e.g. search, impaired driving test, etc.) is not the same as the legal standard for the vehicle stop.

As should be apparent from this detailed description above, the operations and functions of the electronic computing device are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, electronically encoded video, electronically encoded audio, etc., and cannot transmit a notification in respect of a vehicle stop to a display or speaker perceptible by a police officer, among other features and functions set forth herein).

In the foregoing specification, specific embodiments have been described. However, one of ordinary skill in the art appreciates that various modifications and changes can be made without departing from the scope of the invention as set forth in the claims below. For example, employing the image data and/or the violation assessment data to facilitate partial incident or infraction report generation is contemplated. In some cases, this may be carried out contemporaneously with the incident/infraction (for instance, if the police officer is running a report generation tool on his client device at the time he pulls over a vehicle). Partial population of post-incident/infraction report generation is also contemplated.

Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus describeed herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and Ics with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method comprising:
obtaining at least one image within which is shown at least a portion of a vehicle;
receiving, at an at least one processor, image data for the at least one image;
analyzing, using the at least one processor, the image data to generate or facilitate acquisition of violation assessment data associated with the vehicle or an owner of the vehicle;
receiving, at the at least one processor, input originating from a police officer indicating an intention to stop the vehicle;
making a determination, at the at least one processor, whether the violation assessment data supports affirming the stop of the vehicle as a compliant stop, or whether the violation assessment data supports disaffirming the stop of the vehicle; and
transmitting a notification in respect of the stop of the vehicle to a display or speaker perceptible to the police officer, and
wherein the notification informs as to compliancy or non-compliancy of the stop of the vehicle.

2. The method of claim 1 wherein the violation assessment data corresponds to at least one potential vehicle operation violation for the vehicle.

3. The method of claim 1 wherein the violation assessment data corresponds to at least one outstanding arrest warrant against the owner of the vehicle.

4. The method of claim 1 wherein:
the at least a portion of the vehicle includes a license plate of the vehicle, and
the analyzing of the image data includes a license plate recognition operation in relation to the license plate.

5. The method of claim 1 wherein the input originating from the police officer is at least one of a siren switch, a light switch, activation of a megaphone and an audible cue received at a microphone.

6. The method of claim 1 wherein the image data includes video data, and the analyzing the image data includes carrying out video analytics on the video data, an output of which provides at least a portion of the violation assessment data.

7. The method of claim 6 wherein the output includes a detection of erratic driving in relation to the vehicle.

8. The method of claim 1 further comprising partially populating a report document with at least a portion of the image data.

9. The method of claim 1 further wherein the at least one image is captured by an active in-vehicle camera or an active body worn camera.

10. The method of claim 1 further wherein the display is connected or integral to a portable electronic computing device assigned to the police officer.

11. The method of claim 1 wherein:
the at least a portion of the vehicle includes a transparent or open region of the vehicle within which at least one person face is visible, and
the analyzing of the image data includes at least one facial recognition operation in relation to the at least one person face.

12. The method of claim 1 wherein the analyzing the image data includes identifying at least one of make, model and color of the vehicle.

13. The method of claim 1 wherein the display is within or attached to another vehicle assigned to the police officer.

14. The method of claim 1 wherein the display is integral to a handheld device assigned to the police officer.

15. The method of claim 1 further comprising, after making the determination, making a further determination as to whether the violation assessment data supports affirming a search of the vehicle as a compliant search, or whether the violation assessment data supports disaffirming the search.

16. A system comprising:
at least one camera configured to capture at least one image within which is shown at least a portion of a vehicle;
at least one processor, communicatively coupled to the at least one camera, and configured to receive image data therefrom for the at least one image, and the at least one processor further configured to:
analyze the image data to generate or facilitate acquisition of violation assessment data associated with the vehicle or an owner of the vehicle,
receive input originating from a police officer indicating an intention to stop the vehicle,
make a determination whether the violation assessment data supports affirming the stop of the vehicle as a compliant stop, or whether the violation assessment data supports disaffirming the stop of the vehicle, and
generate a notification in respect of the stop of the vehicle; and
a display or speaker, perceptible to the police officer, and communicatively coupled to the at least one processor to receive therefrom the notification that informs as to compliancy or non-compliancy of the stop of the vehicle.
